(19) United States
(12) Patent Application Publication
(10) Pub. No.: US 2025/0337804 A1
(43) Pub. Date: Oct. 30, 2025

(54) SYSTEMS AND METHODS FOR PROVIDING RELIABLE AND LOW LATENCY VOICE CONTROL OF EXTENDED REALITY AND INTERNET OF THINGS DEVICES

(71) Applicant: VERIZON PATENT AND LICENSING INC., BASKING RIDGE, NJ (US)

(72) Inventors: Jin YANG, Orinda, CA (US); Anil Babu VONTIKOMMU, Morris Plains, NJ (US)

(73) Assignee: VERIZON PATENT AND LICENSING INC., BASKING RIDGE, NJ (US)

(21) Appl. No.: 18/645,976

(22) Filed: Apr. 25, 2024

(51) Int. Cl. H04L 65/80; G06F 3/01; G10L 15/22; H04L 43/08

(52) U.S. Cl. CPC H04L 65/80; G06F 3/017; G10L 15/22; H04L 43/08

(57) ABSTRACT

A radio access network (RAN) may receive, from a user device, a video frame, a voice command, and a gesture command associated with an application, and may encode the voice command, the video frame, and the gesture command to generate a data frame. The RAN may determine whether the data frame satisfies a plurality of thresholds associated with a respective plurality of parameters. The RAN may selectively provide the data frame to an application system based on determining that the data frame satisfies the plurality of thresholds, or may adjust one or more of the respective plurality of parameters based on determining that the data frame fails to satisfy at least one of the plurality of thresholds, and provide the data frame to the application system after adjusting the one or more of the respective plurality of parameters.

### BACKGROUND

Extended reality (XR) environments (e.g., virtual reality environments, augmented reality environments, and mixed reality environments) and Internet of Things (IoT) devices have become increasingly prevalent, have been integrated into various aspects of modern life, and have redefined user interaction within digital environments. The domain of extended reality encompasses various technologies that blend digital elements with the physical world, while IoT connects a multitude of devices to the Internet, facilitating a networked ecosystem. Human-computer interactions, including voice control, are utilized within this domain to enable communication between users and technological systems.

### BRIEF DESCRIPTION OF THE DRAWINGS

FIGS. 1A-1E are diagrams of an example associated with providing reliable and low latency voice control of extended reality and IoT devices.

FIG. 2 is a diagram of an example environment in which systems and/or methods described herein may be implemented.

FIG. 3 is a diagram of example components of one or more devices of FIG. 2.

FIG. 4 is a flowchart of an example process for providing reliable and low latency voice control of extended reality and IoT devices.

### DETAILED DESCRIPTION OF EXAMPLE EMBODIMENTS

The following detailed description of example implementations refers to the accompanying drawings. The same reference numbers in different drawings may identify the same or similar elements.

Voice applications, such as voice-over-New-Radio (VoNR), have relatively lenient latency requirements. However, utilizing voice to control extended reality and IoT devices requires stringent latency requirements and high reliability. A current approach for ensuring high reliability and optimized latency for voice-controlled operations requires manual adjustments that are not tailored to the dynamic nature of wireless networks and often lead to trial and error without guaranteeing consistent performance. Moreover, the current approach fails to adequately provide intelligent adjustment of network parameters to meet the stringent demands of latency and reliability for controlling extended reality and IoT devices. Thus, current techniques for utilizing voice control with extended reality and IoT devices may consume computing resources (e.g., processing resources, memory resources, communication resources, and/or the like), networking resources, and/or other resources associated with failing to provide a controlled low latency and high reliability method for voice commands to manage extended reality and IoT devices, failing to synchronize voice frames and other inputs (such as video and gesture controls), failing to provide automated, intelligent radio access network (RAN) controls to ensure consistent and optimal network performance, and/or the like.

Some implementations described herein provide a device (e.g., a RAN) that provides reliable and low latency voice control of extended reality and IoT devices. For example, the RAN may receive, from a user device, a video frame, a voice command, and a gesture command associated with an application, and may encode the voice command, the video frame, and the gesture command to generate a data frame. The RAN may determine whether the data frame satisfies a plurality of thresholds associated with a respective plurality of parameters. The RAN may selectively provide the data frame to an application system based on determining that the data frame satisfies the plurality of thresholds, or may adjust one or more of the respective plurality of parameters based on determining that the data frame fails to satisfy at least one of the plurality of thresholds, and provide the data frame to the application system after adjusting the one or more of the respective plurality of parameters.

In this way, the RAN provides reliable and low latency voice control of extended reality and IoT devices. For example, the RAN may receive a voice command from a user, which is intended for controlling an extended reality device or an IoT device, and may receive a video frame and a gesture command. The RAN may encode the voice command, the video frame, and the gesture command into a data frame for transmission. The RAN may transmit the encoded data frame at a slot level with retransmission at media access control (MAC) and packet data convergence protocol (PDCP) aggregation levels to ensure high reliability and low latency control of the extended reality device or the IoT device. Additionally, the RAN may dynamically adjust latency and reliability thresholds during operation and provide a hybrid automatic repeat request (HARQ) process when the encoded data frame fails to meet predefined reliability criteria. Thus, the RAN may conserve computing resources, networking resources, and/or other resources that would have otherwise been consumed by failing to provide a controlled low latency and high reliability method for voice commands to manage extended reality and IoT devices, failing to synchronize voice frames and other inputs (such as video and gesture controls), failing to provide automated, intelligent RAN controls to ensure consistent and optimal network performance, and/or the like.

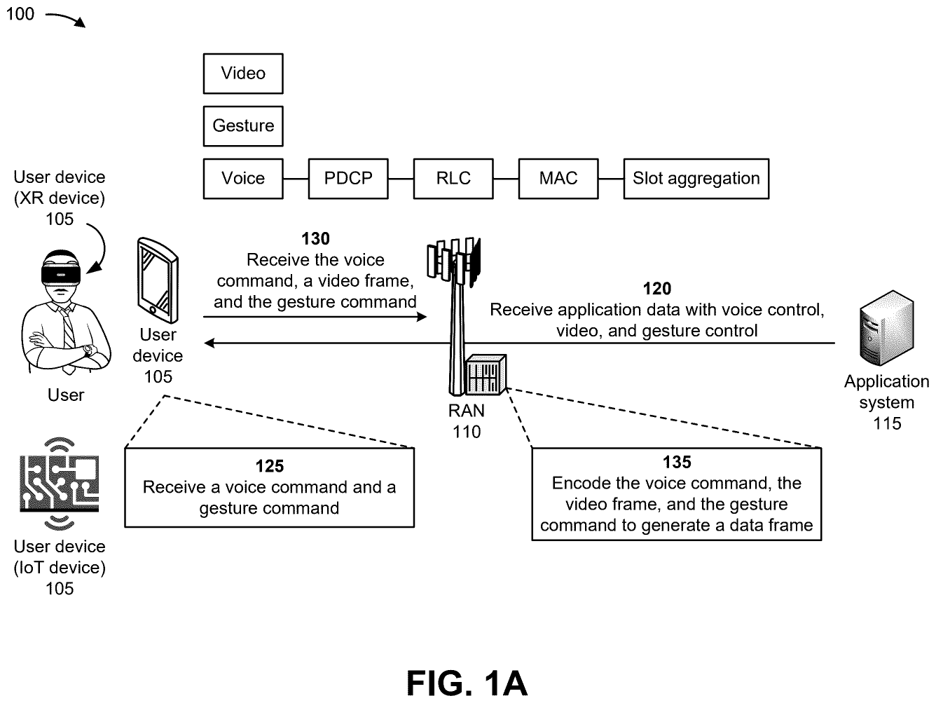

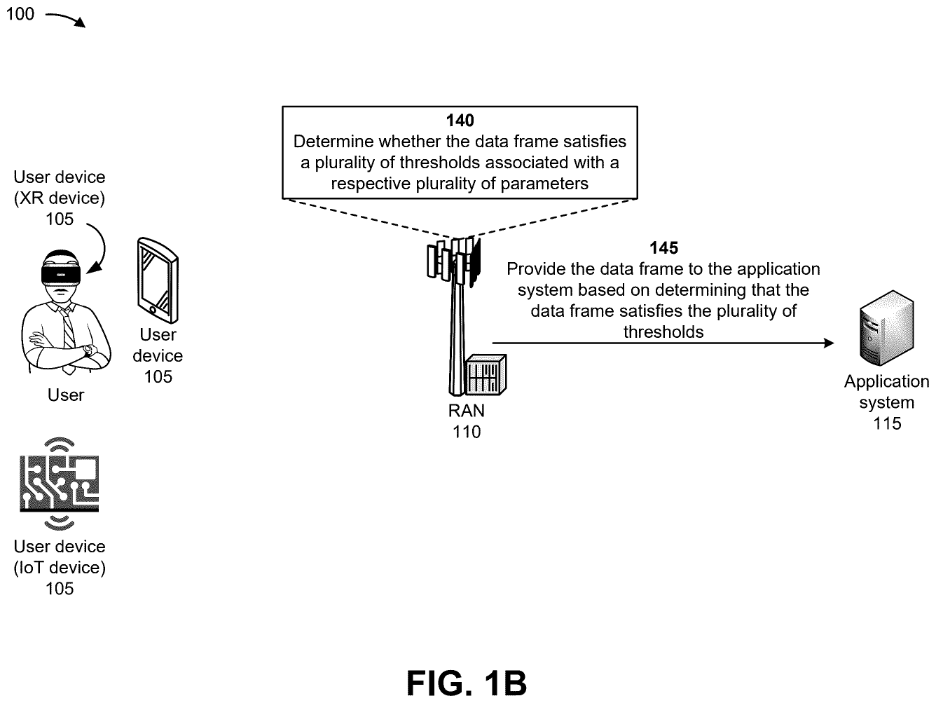

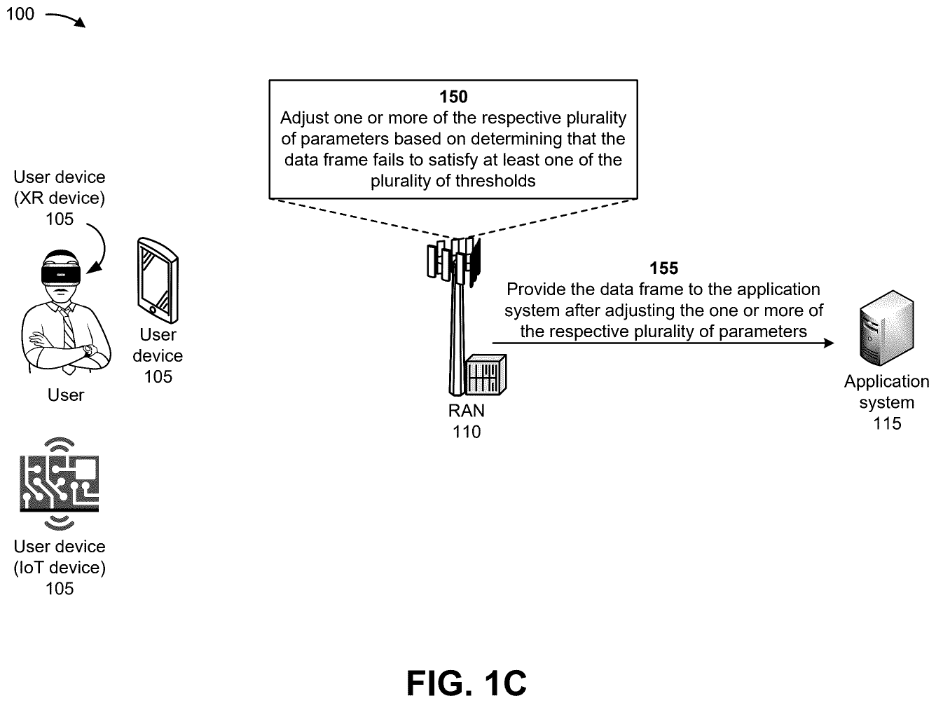

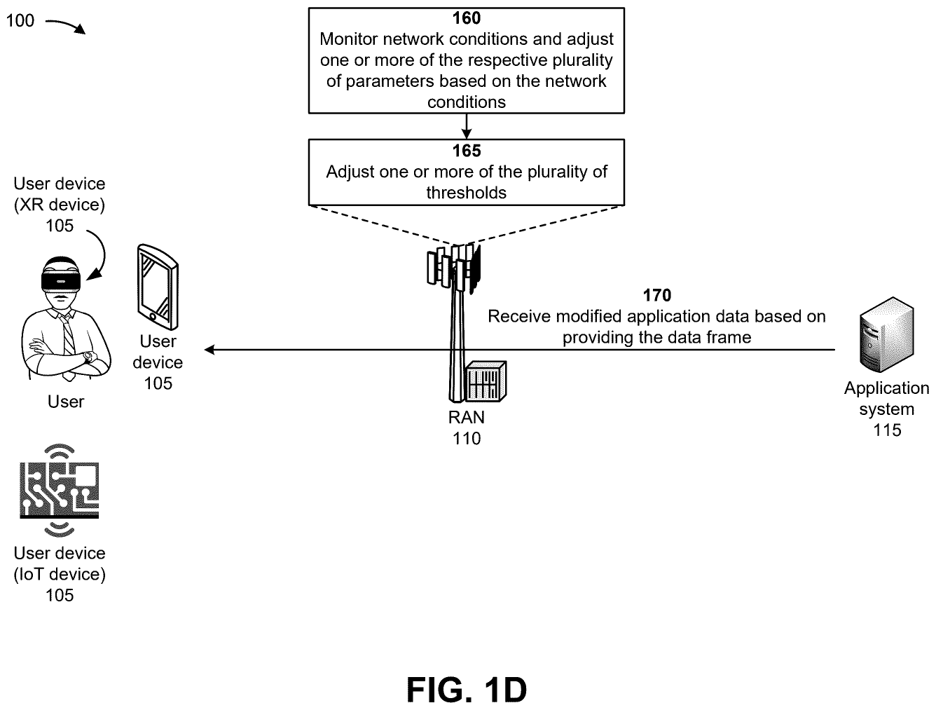

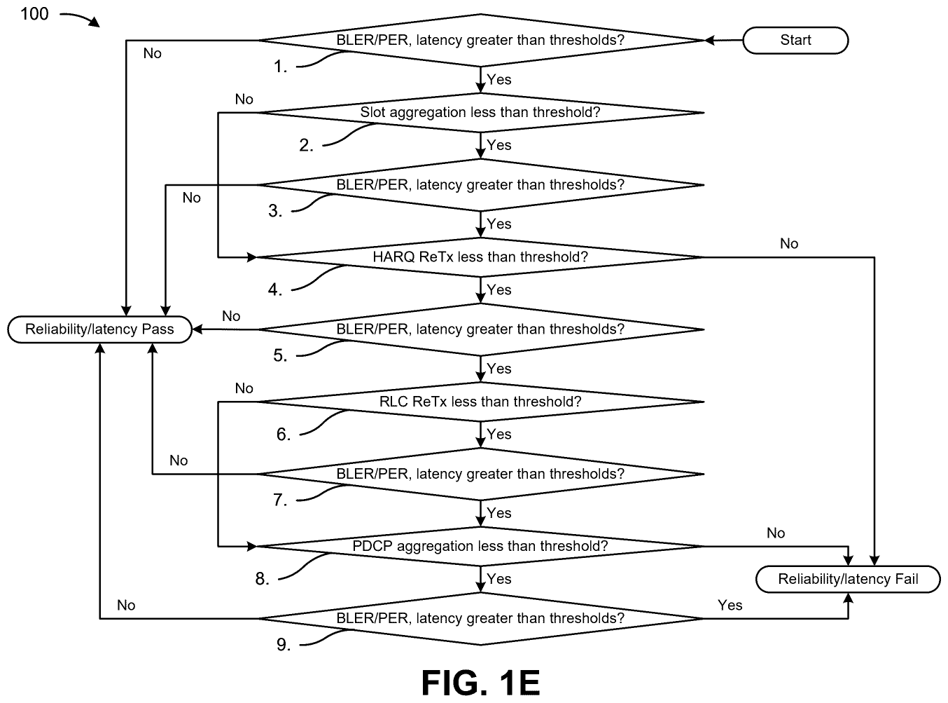

FIGS. 1A-1E are diagrams of an example 100 associated with providing reliable and low latency voice control of extended reality and IoT devices. As shown in FIGS. 1A-1E, example 100 includes a user device 105 (e.g., associated with a user), a RAN 110, and an application system 115. In some implementations, the user device 105 may include an IoT device, a headset for use in a virtual reality environment, an augmented reality environment, and/or a mixed reality environment, and/or the like. Further details of the user device 105, the RAN 110, and the application system 115 are provided elsewhere herein. In some implementations, one or more of the functions described herein as being performed by the RAN 110 may be performed by the user device 105.

As shown in FIG. 1A, and by reference number 120, the user device 105 may receive application data with voice control, video, and gesture control. For example, the application system 115 may provide the application data to the RAN 110, and the RAN 110 may provide the application data to the user device 105. The user device 105 may receive the application data from the RAN 110. In some implementations, the application data may include data identifying a virtual reality application, an augmented reality application, a mixed reality application, an IoT application, and/or the like. The application may include video associated with the application and may enable a user of the application to control the video and/or a physical object (e.g., IoT device) associated with the video via voice commands and/or gesture commands.

The application system 115 may transmit application data to the user device 105, enabling a user of the user device 105 to interact with the application through various input techniques, such as voice commands and/or gesture commands. In some aspects, the user device 105 may retrieve the application data from a cloud-based service or may download the application data from an application store. In some aspects, a user experience may be enhanced by providing the user device 105 with immediate access to the latest versions and features of the application.

As further shown in FIG. 1A, and by reference number 125, the user device 105 may receive a voice command and a gesture command. For example, the user may utilize the user device 105 to interact with the video provided by the application. In some implementations, the user (e.g., via the user device 105) may interact with the application through various input techniques, such as a voice command and/or a gesture command. The user device 105 may receive the voice command and the gesture command from the user. In some implementations, the user device 105 may receive only the voice command and may not receive the gesture command. Additionally, or alternatively, the user device 105 may receive not only the voice command and the gesture command, but also additional inputs, such as touch inputs or eye-tracking data associated with the user. Such additional inputs may provide a more immersive and intuitive user experience, allowing for a broader range of interactions with the application.

As further shown in FIG. 1A, and by reference number 130, the RAN 110 may receive the voice command, a video frame, and the gesture command from the user device 105. For example, the user device 105 may provide the voice command, a video frame, and the gesture command to the RAN 110, and the RAN 110 may receive the voice command, the video frame, and the gesture command from the user device 105. The video frame may correspond to a video frame provided by the application to the user device 105 during receipt of the voice command and/or the gesture command. In some implementations, the RAN 110 may receive the voice command, the video frame, and the gesture command from the user device 105 via different communication protocols, such as Wi-Fi, Bluetooth, near-field communication (NFC), and/or the like. This may enhance a flexibility and a robustness of the data transmission, and may cater to different user environments and capabilities of the user device 105.

As further shown in FIG. 1A, and by reference number 135, the RAN 110 may encode the voice command, the video frame, and the gesture command to generate a data frame. For example, the RAN 110 may encode the voice command, the video frame, and the gesture command using various encoding techniques, such as advanced audio coding (AAC), enhanced voice services (EVS) coding, and adaptive multi-rate wideband (AMR-WB) coding for the voice command or H.264 for the video frame, to generate the data frame. Employing different encoding techniques may optimize the data frame for specific transmission requirements, potentially improving audio and video quality while maintaining efficient use of network resources. In some implementations, when encoding the voice command, the video frame, and the gesture command to generate the data frame, the RAN 110 may synchronize the voice command with the video frame and the gesture command within the data frame, ensuring that the data frame is encoded with all inputs aligned. This synchronization may be required for applications that rely on the precise timing of multiple input types, such as augmented reality or virtual reality applications. In this way, the data frame may provide context for the voice command relative to the video frame and/or the gesture command. The context may be utilized by the application system 115 to determine how to implement the voice command via the application.

As shown in FIG. 1B, and by reference number 140, the RAN 110 may determine whether the data frame satisfies a plurality of thresholds associated with a respective plurality of parameters. For example, the RAN 110 may analyze the data frame, which includes the encoded voice command, video frame, and gesture command, to determine whether the data frame satisfies predefined criteria (e.g., the plurality of thresholds) for the respective plurality of parameters, such as latency, reliability, error rates (e.g., packet error rate (PER) or block error rate (BLER)), and/or the like. This determination may ensure that the data frame is suitable for transmission to the application system 115, which may be reliant on receiving data with certain performance features in order to function correctly.

In some aspects, the RAN 110 may evaluate the data frame against thresholds for alternative or additional parameters beyond latency, reliability, and error rates, such as signal strength, data integrity, and/or the like. This may involve determining a robustness of the data frame against various transmission thresholds, ensuring that the data frame not only meets the basic thresholds but also maintains integrity and strength during transmission. Additionally, or alternatively, the RAN 110 may determine whether the data frame satisfies other parameters, such as a signal-to-noise ratio or jitter, instead of or in addition to the error rates. These parameters may provide a more nuanced understanding of a quality of the data frame, allowing for more precise adjustments to be made to meet requirements of the application system 115. Additionally, or alternatively, the RAN 110 may adjust the plurality of thresholds dynamically based on historical data trends or predictive modeling to anticipate network conditions (e.g., degrading network conditions). This proactive approach can lead to more efficient data frame transmission by adapting to changing network environments in real-time.

As further shown in FIG. 1B, and by reference number 145, the RAN 110 may provide the data frame to the application system 115 based on determining that the data frame satisfies the plurality of thresholds. For example, when the data frame satisfies the plurality of thresholds, the RAN 110 may forward the data frame to the application system 115, which may be configured to receive and process the data frame for controlling the application (e.g., an extended reality application and/or IoT devices). In some aspects, the provision of the data frame to the application system 115 may occur at a slot level with retransmission at MAC and PDCP aggregation levels, ensuring optimized spectral efficiency during transmission.

In some aspects, the RAN 110 may provide the data frame to the application system 115 using alternative transmission methods, such as bundling with other data frames for batch processing or using diverse levels of protocol aggregation. These alternative transmission methods may enhance the efficiency of data transmission, especially in scenarios where multiple data frames need to be sent in a coordinated manner. Additionally, or alternatively, the RAN 110 may initiate a HARQ process for adjusting parameters if the data frame fails to satisfy the one or more of the plurality of thresholds. The HARQ process may ensure that the data frame is eventually transmitted successfully by allowing for intelligent retransmission strategies. Additionally, or alternatively, the RAN 110 may prioritize certain parameters over other parameters so that the transmission process for the data frame may be tailored to specific needs of the application system 115 and/or the user device 105. In this way, the RAN 110 may ensure high reliability and optimized latency for controlling IoT devices and extended reality devices using voice commands. By determining whether the plurality of thresholds are satisfied and providing the data frame accordingly, the RAN 110 may maintain a target latency and reliability, which may provide for seamless operation of the application system 115 and the user device 105.

As shown in FIG. 1C, and by reference number 150, the RAN 110 may adjust one or more of the respective plurality of parameters based on determining that the data frame fails to satisfy at least one of the plurality of thresholds. For example, when the data frame fails to satisfy at least one of the plurality of thresholds, the RAN 110 may adjust one or more of the respective plurality of parameters. In some aspects, the RAN 110 may adjust the at least one of the plurality of thresholds based on transmission requirements of the data frame and to provide reliable and low latency voice control of the application. Additionally, or alternatively, the RAN 110 may adjust thresholds associated with parameters like power levels, modulation schemes, or error correction codes based on the transmission requirements of the data frame. Adjusting thresholds may lead to more precise control over transmission quality of the data frame, and may ensure that the data frame is transmitted with the necessary robustness and clarity.

In some implementations, the RAN 110 may initiate a HARQ process to adjust the one or more of the plurality of parameters and to ensure that the data frame meets the required thresholds for latency and reliability before being provided to the application system 115. In some aspects, the RAN 110 may adjust the thresholds for latency and reliability based on transmission requirements of the data frame before determining whether the data frame satisfies the thresholds. Such a preemptive adjustment may provide a more tailored approach to satisfying specific needs of data frame transmission, and may ensure that the thresholds are aligned with data frame requirements. Additionally, or alternatively, the RAN 110 may monitor network conditions and adjust one or more of the plurality of parameters based on the network conditions. This dynamic adjustment may ensure that the data frame is processed in a manner that is responsive to a current state of the network, which can vary due to a multitude of factors, such as congestion or signal strength. Additionally, or alternatively, the RAN 110 may selectively bundle the data frame with other data frames at a slot level to optimize spectral efficiency during transmission. By doing so, the RAN 110 can enhance the overall transmission efficiency, which may be beneficial when bandwidth is at a premium.

As further shown in FIG. 1C, and by reference number 155, the RAN 110 may provide the data frame to the application system 115 after adjusting the one or more of the respective plurality of parameters. For example, after adjusting the one or more of the respective plurality of parameters, the RAN 110 may forward the data frame to the application system 115, which may be configured to receive and process the data frame for controlling the application. In some aspects, the provision of the data frame to the application system 115 may occur at a slot level with retransmission at MAC and PDCP aggregation levels, ensuring optimized spectral efficiency during transmission. In some implementations, the RAN 110 may determine an optimal quantity of slot aggregations required to meet latency and reliability targets, and may utilize the optimal quantity of slot aggregations to provide the data frame to the application system 115. This may ensure that the data frame is transmitted in a most efficient manner possible, taking into account the specific latency and reliability requirements. Additionally, or alternatively, the RAN 110 may determine a performance associated with providing the data frame to the application system 115, and may select a retransmission count for subsequent data frames received from the user device 105 based on the performance. This may allow for continuous improvement in the transmission process, as the RAN 110 can adjust strategies based on the observed performance outcomes. In this way, the RAN 110 may provide enhanced control and automation of adjusting the parameters or thresholds in order to guarantee the reliability and latency targets at each stage of transmission of the data frame. This may lead to more efficient and reliable communication between the user device 105 and the application system 115.

As shown in FIG. 1D, and by reference number 160, the RAN 110 may monitor network conditions and may adjust one or more of the respective plurality of parameters based on the network conditions. For example, the RAN 110 may assess current network traffic, signal strength, and other relevant conditions to determine optimal settings for parameters that affect data transmission, such as retransmission rates and slot aggregation counts. This monitoring and adjustment process may ensure that the data frame is transmitted with a desired level of reliability and latency. In some aspects, the RAN 110 may evaluate signal-to-noise ratios and may adjust modulation and coding schemes to optimize data transmission. This may involve selecting higher order modulation schemes under good signal conditions to increase data rates, or switching to more robust coding schemes when signal quality is poor to enhance error correction capabilities. Additionally, or alternatively, the RAN 110 may implement dynamic frequency selection to mitigate interference and improve data frame transmission quality. This may involve scanning for less congested frequency bands and reallocating transmission to those frequencies to reduce the likelihood of interference from other signals. Additionally, or alternatively, the RAN 110 may adjust the power control settings to enhance signal strength and ensure reliable data frame delivery. This may include increasing the transmit power to overcome path loss and fading, or reducing power to minimize interference with other devices.

As further shown in FIG. 1D, and by reference number 165, the RAN 110 may adjust one or more of the plurality of thresholds. For example, the RAN 110 may adjust one or more of the plurality of thresholds based on transmission requirements of the data frame to meet specific application requirements, such as requirements for extended reality and IoT devices. By dynamically modifying the one or more of the plurality of thresholds, the RAN 110 can optimize transmission of the data frame for latency and reliability, ensuring that the application system 115 receives the data frame in a state that is most conducive to utilization with the application. In some aspects, the RAN 110 may adjust the thresholds for jitter and packet loss to accommodate quality of service (QOS) requirements of different applications. This may involve setting stricter thresholds for applications that are sensitive to delays and data loss, such as real-time video streaming, while allowing more leniency for less time-critical applications. Additionally, or alternatively, the RAN 110 may implement a fast retransmission protocol to quickly recover from data frame losses without significantly impacting latency. This protocol may detect lost or corrupted data frames and may initiate an immediate retransmission, rather than waiting for a timeout period to expire.

As further shown in FIG. 1D, and by reference number 170, the user device 105 may receive modified application data based on providing the data frame. For example, the application system 115 may receive the data frame with the voice command and the gesture command, and may modify the application data based on the voice command and/or the gesture command and to generate the modified application data. In some implementations, the application system 115 may modify the video presented to the user via the application based on the voice command and/or the gesture command, may cause the IoT device to perform a function (e.g., changing video presented to the user via the application) based on the voice command and/or the gesture command, and/or the like. The application system 115 may provide the modified application data to the RAN 110, and the RAN 110 may provide the modified application data to the user device 105. The user device 105 may receive the modified application data from the RAN 110.

The modified application data may include updated control commands or feedback based on the voice command, the video frame, and/or the gesture command. The feedback may provide for a responsive and interactive experience for the user, enhancing the control and functionality of extended reality and IoT devices. In some aspects, the RAN 110 may incorporate feedback from the application system 115 regarding the performance of received data frames to refine parameter adjustments. The RAN 110 may use this feedback to assess the effectiveness of the current parameter settings and make data-driven decisions to further optimize transmission quality. Additionally, or alternatively, the RAN 110 may apply machine learning models to predict the optimal parameter settings based on historical data frame transmission patterns. These models may analyze past transmission data to identify trends and correlations that can inform future parameter adjustments, leading to a more intelligent and adaptive network.

FIG. 1E depicts an example flow chart associated with the RAN 110 determining whether the data frame satisfies the plurality of thresholds associated with the respective plurality of parameters. As shown at step 1, the RAN 110 may determine whether each of the BLER, the PER, and the latency associated with the data frame are greater than corresponding BLER, PER, and latency thresholds. If the RAN 110 determines that each of the BLER, the PER, and the latency associated with the data frame are not greater than the corresponding BLER, PER, and latency thresholds (step 1—No), the RAN 110 may determine that the data frame passes reliability and/or latency requirements for provision to the application system 115. If the RAN 110 determines that each of the BLER, the PER, and the latency associated with the data frame are greater than the corresponding BLER, PER, and latency thresholds (step 1—Yes), the RAN 110 may determine whether the slot aggregation associated with the data frame is less than a slot aggregation threshold (step 2). If the RAN 110 determines that the slot aggregation associated with the data frame is less than the slot aggregation threshold (step 2—Yes), the RAN 110 may once again determine whether each of the BLER, the PER, and the latency associated with the data frame are greater than the corresponding BLER, PER, and latency thresholds (step 3). If the RAN 110 determines that the slot aggregation associated with the data frame is not less than the slot aggregation threshold (step 2—No), the RAN 110 may determine whether the HARQ retransmission (ReTx) is less than a HARQ ReTx threshold (step 4).

If the RAN 110 determines that each of the BLER, the PER, and the latency associated with the data frame are not greater than the corresponding BLER, PER, and latency thresholds (step 3—No), the RAN 110 may determine that the data frame passes the reliability and/or latency requirements for provision to the application system 115. If the RAN 110 determines that each of the BLER, the PER, and the latency associated with the data frame are greater than the corresponding BLER, PER, and latency thresholds (step 3—Yes), the RAN 110 may determine whether the HARQ ReTx is less than the HARQ ReTx threshold (step 4). If the RAN 110 determines that the HARQ ReTx is not less than the HARQ ReTx threshold (step 4-No), the RAN 110 may determine that the data frame fails the reliability and/or latency requirements for provision to the application system 115. If the RAN 110 determines that the HARQ ReTx is less than the HARQ ReTx threshold (step 4—Yes), the RAN 110 may once again determine whether each of the BLER, the PER, and the latency associated with the data frame are greater than the corresponding BLER, PER, and latency thresholds (step 5).

If the RAN 110 determines that each of the BLER, the PER, and the latency associated with the data frame are not greater than the corresponding BLER, PER, and latency thresholds (step 5—No), the RAN 110 may determine that the data frame passes the reliability and/or latency requirements for provision to the application system 115. If the RAN 110 determines that each of the BLER, the PER, and the latency associated with the data frame are greater than the corresponding BLER, PER, and latency thresholds (step 5—Yes), the RAN 110 may determine whether the radio link control (RLC) ReTx associated with the data frame is less than an RLC ReTx threshold (step 6). If the RAN 110 determines that the RLC ReTx associated with the data frame is less than the RLC ReTx threshold (step 6—Yes), the RAN 110 may once again determine whether each of the BLER, the PER, and the latency associated with the data frame are greater than the corresponding BLER, PER, and latency thresholds (step 7). If the RAN 110 determines that the RLC ReTx associated with the data frame is not less than the RLC ReTx threshold (step 6—No), the RAN 110 may determine whether the PDCP aggregation associated with the data frame is less than a PDCP aggregation threshold (step 8).

If the RAN 110 determines that each of the BLER, the PER, and the latency associated with the data frame are not greater than the corresponding BLER, PER, and latency thresholds (step 7—No), the RAN 110 may determine that the data frame passes the reliability and/or latency requirements for provision to the application system 115. If the RAN 110 determines that each of the BLER, the PER, and the latency associated with the data frame are greater than the corresponding BLER, PER, and latency thresholds (step 7—Yes), the RAN 110 may determine whether the PDCP aggregation associated with the data frame is less than the PDCP aggregation threshold (step 8). If the RAN 110 determines that the PDCP aggregation associated with the data frame is not less than the PDCP aggregation threshold (step 8—No), the RAN 110 may determine that the data frame fails the reliability and/or latency requirements for provision to the application system 115. If the RAN 110 determines that the PDCP aggregation associated with the data frame is less than the PDCP aggregation threshold (step 8—Yes), the RAN 110 may once again determine whether each of the BLER, the PER, and the latency associated with the data frame are greater than the corresponding BLER, PER, and latency thresholds (step 9).

If the RAN 110 determines that each of the BLER, the PER, and the latency associated with the data frame are not greater than the corresponding BLER, PER, and latency thresholds (step 9—No), the RAN 110 may determine that the data frame passes the reliability and/or latency requirements for provision to the application system 115. If the RAN 110 determines that each of the BLER, the PER, and the latency associated with the data frame are greater than the corresponding BLER, PER, and latency thresholds (step 9—Yes), the RAN 110 may determine that the data frame fails the reliability and/or latency requirements for provision to the application system 115.

In some implementations, the RAN 110 may utilize one or more different parameters and/or thresholds, one or more additional parameters and/or thresholds, one or more fewer parameters and/or thresholds, or one or more differently arranged parameters and/or thresholds than those shown in FIG. 1E.

In this way, the RAN 110 provides reliable and low latency voice control of extended reality and IoT devices. For example, the RAN 110 may receive a voice command from a user, which is intended for controlling an extended reality device or an IoT device, and may receive a video frame and a gesture command. The RAN 110 may encode the voice command, the video frame, and the gesture command into a data frame for transmission. The RAN 110 may transmit the encoded data frame at a slot level with retransmission at MAC and PDCP aggregation levels to ensure high reliability and low latency control of the extended reality device or the IoT device. Additionally, the RAN 110 may dynamically adjust latency and reliability thresholds during operation and provide a HARQ process when the encoded data frame fails to meet predefined reliability criteria. Thus, the RAN may conserve computing resources, networking resources, and/or other resources that would have otherwise been consumed by failing to provide a controlled low latency and high reliability method for voice commands to manage extended reality and IoT devices, failing to synchronize voice frames and other inputs, such as video and gesture controls, failing to provide automated, intelligent RAN controls to ensure consistent and optimal network performance, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

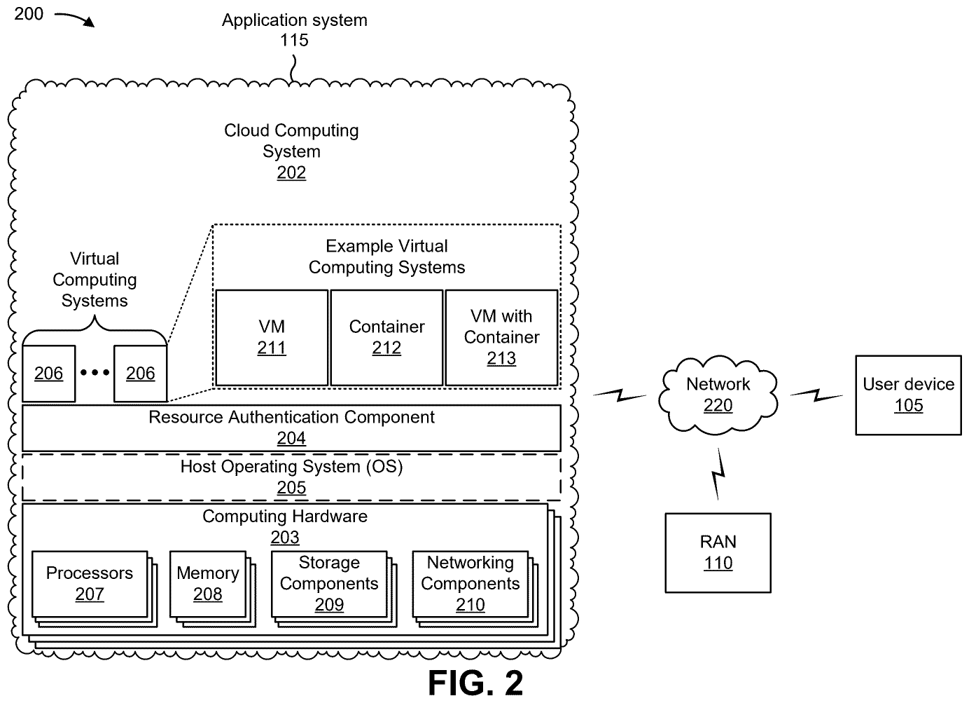

FIG. 2 is a diagram of an example environment 200 in which systems and/or methods described herein may be implemented. As shown in FIG. 2, the environment 200 may include the application system 115, which may include one or more elements of and/or may execute within a cloud computing system 202. The cloud computing system 202 may include one or more elements 203-213, as described in more detail below. As further shown in FIG. 2, the environment 200 may include the user device 105, the RAN 110, and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a virtual assistant device, or a similar type of device.

The RAN 110 may support, for example, a cellular radio access technology (RAT). The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the user device 105. The RAN 110 may transfer traffic between the user device 105 (e.g., using a cellular RAT), one or more base stations (e.g., using a wireless interface or a backhaul interface, such as a wired backhaul interface), and/or the application system 115. The RAN 110 may provide one or more cells that cover geographic areas.

In some implementations, the RAN 110 may perform scheduling and/or resource management for the user device 105 covered by the RAN 110 (e.g., a user device 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the user device 105 covered by the RAN 110).

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

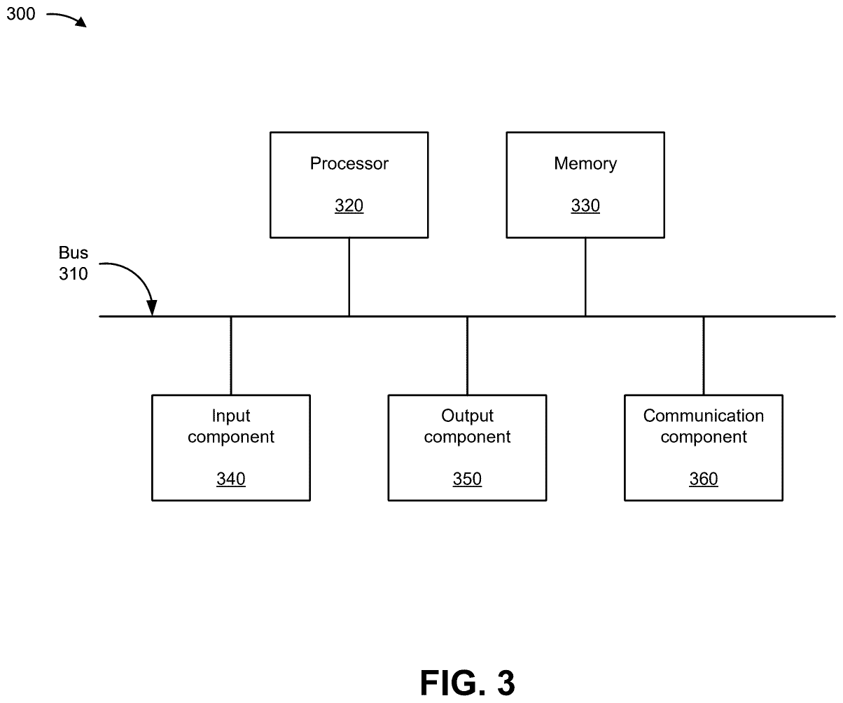

Although the application system 115 may include one or more elements 203-213 of the cloud computing system 202, may execute within the cloud computing system 202, and/or may be hosted within the cloud computing system 202, in some implementations, the application system 115 may not be cloud-based (e.g., may be implemented outside of a cloud computing system) or may be partially cloud-based. For example, the application system 115 may include one or more devices that are not part of the cloud computing system 202, such as the device 300 of FIG. 3, which may include a standalone server or another type of computing device. The application system 115 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the RAN 110, and/or the application system 115. In some implementations, the user device 105, the RAN 110, and/or the application system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

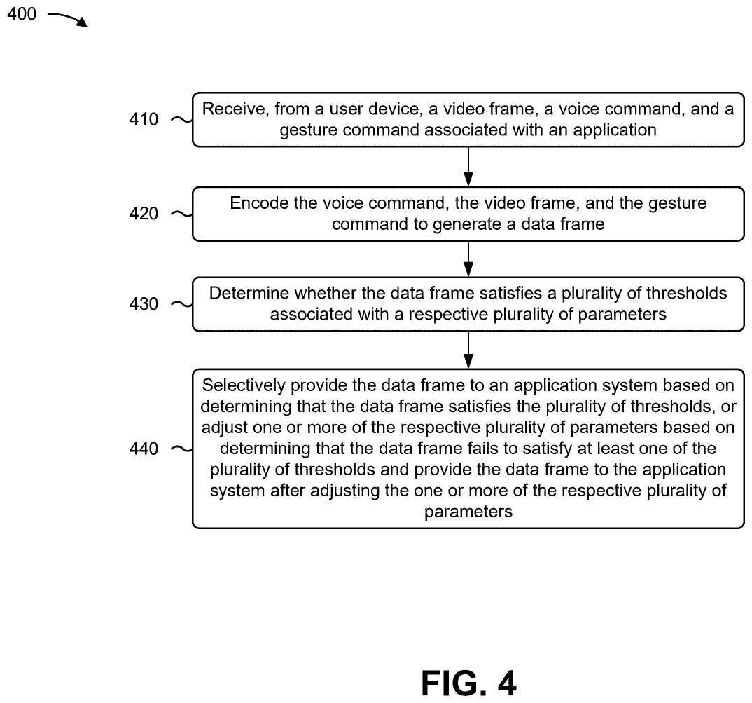

FIG. 4 is a flowchart of an example process 400 for providing reliable and low latency voice control of extended reality and IoT devices. In some implementations, one or more process blocks of FIG. 4 may be performed by a device (e.g., the RAN 110). In some implementations, one or more process blocks of FIG. 4 may be performed by another device or a group of devices separate from or including the device, such as a user device (e.g., the user device 105) and/or an application system (e.g., the application system 115). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a user device, a video frame, a voice command, and a gesture command associated with an application (block 410). For example, the RAN may receive, from a user device, a video frame, a voice command, and a gesture command associated with an application, as described above.

As further shown in FIG. 4, process 400 may include encoding the voice command, the video frame, and the gesture command to generate a data frame (block 420). For example, the RAN may encode the voice command, the video frame, and the gesture command to generate a data frame, as described above. In some implementations, encoding the voice command, the video frame, and the gesture command to generate the data frame includes synchronizing the voice command with the video frame and the gesture command within the data frame.

As further shown in FIG. 4, process 400 may include determining whether the data frame satisfies a plurality of thresholds associated with a respective plurality of parameters (block 430). For example, the RAN may determine whether the data frame satisfies a plurality of thresholds associated with a respective plurality of parameters, as described above.

As further shown in FIG. 4, process 400 may include selectively providing the data frame to an application system based on determining that the data frame satisfies the plurality of thresholds, or adjusting one or more of the respective plurality of parameters based on determining that the data frame fails to satisfy at least one of the plurality of thresholds, and providing the data frame to the application system after adjusting the one or more of the respective plurality of parameters (block 440). For example, the RAN may selectively provide the data frame to an application system based on determining that the data frame satisfies the plurality of thresholds, or adjust one or more of the respective plurality of parameters (e.g., via automation) based on determining that the data frame fails to satisfy at least one of the plurality of thresholds, and provide the data frame to the application system after adjusting the one or more of the respective plurality of parameters, as described above.

In some implementations, providing the data frame to the application system includes providing the data frame to the application system at a slot level, with retransmission at media access control and packet data convergence protocol aggregation levels. In some implementations, providing the data frame to the application system includes bundling the data frame with other data frames at a slot level to optimize spectral efficiency during transmission relative to not bundling the data frame with the other data frames.

In some implementations, adjusting the one or more of the respective plurality of parameters initiating a hybrid automatic repeat request process to adjust the one or more of the respective plurality of parameters. In some implementations, providing the data frame to the application system includes determining an optimal quantity of slot aggregations required to meet latency and reliability targets, and utilizing the optimal quantity of slot aggregations to provide the data frame to the application system.

In some implementations, process 400 includes monitoring network conditions, and adjusting one or more of the respective plurality of parameters based on the network conditions. In some implementations, process 400 includes adjusting thresholds for latency and reliability, of the plurality of thresholds, based on transmission requirements of the data frame. In some implementations, process 400 includes receiving modified application data based on providing the data frame. In some implementations, process 400 includes automating control of retransmission rates at a media access control level based on a target block error rate for the data frame.

In some implementations, process 400 includes aggregating the data frame with other data frames at a packet data convergence protocol aggregation level to maintain a target latency. In some implementations, process 400 includes analyzing radio link control parameters to determine optimal retransmission strategies for the data frame. In some implementations, process 400 includes calculating a packet error rate to assess a quality of transmission of the data frame. In some implementations, process 400 includes modifying an order associated with the respective plurality of parameters to optimize control of the user device. In some implementations, process 400 includes determining a performance of providing the data frame to the application system, and selecting a retransmission count for subsequent data frames received from the user device based on the performance.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a radio access network (RAN) and from a user device, a video frame, a voice command, and a gesture command associated with an application;
encoding, by the RAN, the voice command, the video frame, and the gesture command to generate a data frame;
determining, by the RAN, whether the data frame satisfies a plurality of thresholds associated with a respective plurality of parameters; and
selectively:
providing the data frame to an application system based on determining that the data frame satisfies the plurality of thresholds, or
adjusting one or more of the respective plurality of parameters based on determining that the data frame fails to satisfy at least one of the plurality of thresholds, and providing the data frame to the application system after adjusting the one or more of the respective plurality of parameters.

2. The method of claim 1, further comprising:
monitoring network conditions; and
adjusting one or more of the respective plurality of parameters based on the network conditions.

3. The method of claim 1, further comprising:
adjusting thresholds for latency and reliability, of the plurality of thresholds, based on transmission requirements of the data frame.

4. The method of claim 1, further comprising:
receiving modified application data based on providing the data frame.

5. The method of claim 1, wherein encoding the voice command, the video frame, and the gesture command to generate the data frame comprises:
synchronizing the voice command with the video frame and the gesture command within the data frame.

6. The method of claim 1, wherein providing the data frame to the application system comprises:
providing the data frame to the application system at a slot level, with retransmission at media access control and packet data convergence protocol aggregation levels.

7. The method of claim 1, wherein providing the data frame to the application system comprises:
bundling the data frame with other data frames at a slot level to optimize spectral efficiency during transmission relative to not bundling the data frame with the other data frames.

8. A radio access network, comprising:
one or more processors configured to:
receive, from a user device, a video frame, a voice command, and a gesture command associated with an application;
encode the voice command, the video frame, and the gesture command to generate a data frame;
determine whether the data frame satisfies a plurality of thresholds associated with a respective plurality of parameters;
selectively:
provide the data frame to an application system based on determining that the data frame satisfies the plurality of thresholds, or
adjust one or more of the respective plurality of parameters based on determining that the data frame fails to satisfy at least one of the plurality of thresholds, and provide the data frame to the application system after adjusting the one or more of the respective plurality of parameters; and
receive modified application data based on providing the data frame.

9. The radio access network of claim 8, wherein the one or more processors are further configured to:
automate control of retransmission rates at a media access control level based on a target block error rate for the data frame.

10. The radio access network of claim 8, wherein the one or more processors are further configured to:
aggregate the data frame with other data frames at a packet data convergence protocol aggregation level to maintain a target latency.

11. The radio access network of claim 8, wherein the one or more processors are further configured to:
analyze radio link control parameters to determine optimal retransmission strategies for the data frame.

12. The radio access network of claim 8, wherein the one or more processors are further configured to:
calculate a packet error rate to assess a quality of transmission of the data frame.

13. The radio access network of claim 8, wherein the one or more processors, to adjust the one or more of the respective plurality of parameters, are configured to:
initiate a hybrid automatic repeat request process to adjust the one or more of the respective plurality of parameters.

14. The radio access network of claim 8, wherein the one or more processors are further configured to:
modify an order associated with the respective plurality of parameters to optimize control of the user device.

15. A non-transitory computer-readable medium storing a set of instructions, the set of instructions comprising:
one or more instructions that, when executed by one or more processors of a radio access network, cause the radio access network to:
receive, from a user device, a video frame and a voice command associated with an application;
encode the voice command and the video frame to generate a data frame;
adjust a plurality of thresholds associated with a respective plurality of parameters based on transmission requirements of the data frame;
determine whether the data frame satisfies the plurality of thresholds; and
selectively:
provide the data frame to an application system based on determining that the data frame satisfies the plurality of thresholds, or
adjust one or more of the respective plurality of parameters based on determining that the data frame fails to satisfy at least one of the plurality of thresholds, and provide the data frame to the application system after adjusting the one or more of the respective plurality of parameters.

16. The non-transitory computer-readable medium of claim 15, wherein the one or more instructions, that cause the radio access network to provide the data frame to the application system, cause the radio access network to:
determine an optimal quantity of slot aggregations required to meet latency and reliability targets; and
utilize the optimal quantity of slot aggregations to provide the data frame to the application system.

17. The non-transitory computer-readable medium of claim 15, wherein the one or more instructions further cause the radio access network to:
determine a performance of providing the data frame to the application system; and
select a retransmission count for subsequent data frames received from the user device based on the performance.

18. The non-transitory computer-readable medium of claim 15, wherein the one or more instructions further cause the radio access network to:
monitor network conditions; and
adjust one or more of the respective plurality of parameters based on the network conditions.

19. The non-transitory computer-readable medium of claim 15, wherein the one or more instructions, that cause the radio access network to encode the voice command and the video frame to generate the data frame, cause the radio access network to:
synchronize the voice command with the video frame within the data frame.

20. The non-transitory computer-readable medium of claim 15, wherein the one or more instructions, that cause the radio access network to provide the data frame to the application system, cause the radio access network to:
provide the data frame to the application system at a slot level, with retransmission at media access control and packet data convergence protocol aggregation levels.
